(19) United States
(12) Patent Application Publication
(10) Pub. No.: US 2005/0197257 A1
(43) Pub. Date: Sep. 8, 2005

(54) Subterranean acidizing treatment fluids and methods of using these fluids in subterranean formations

(76) Inventor: Ron C.M. Bouwmeester, Oude Wetering (NL)

Correspondence Address: Robert A. Kent;Halliburton Energy Services, 2600 South 2nd Street, Duncan, OK, 73536-0440, US

(21) Appl. No.: 10/793,710

(22) Filed: Mar. 5, 2004

(51) Int. Cl. C09K 7/02

(52) U.S. Cl. 507/120

(57) ABSTRACT

The present invention provides acidizing treatment fluids that comprise a base fluid comprising an acid, a crosslinkable gelling agent that comprises a copolymer of an alkenoic acid and an acrylamide derivative, and a crosslinking agent. In addition, the present invention provides methods of acidizing a subterranean formation that comprise contacting the subterranean formation with an acidizing treatment fluid that comprises a base fluid comprising an acid, a crosslinkable gelling agent that comprises a copolymer of an alkenoic acid and an acrylamide derivative, and a crosslinking agent. Optionally, the acidizing treatment fluids of the present invention further may comprise sulfide scavengers.

### BACKGROUND OF THE INVENTION

The present invention relates to subterranean treatment operations, and more specifically, to improved acidizing treatment fluids that are compatible with sulfide scavengers and methods of using such acidizing treatment fluids in subterranean formations.

The production of desirable fluids (e.g., oil and gas) from subterranean formations may often be enhanced by stimulating a region of the formation surrounding a well bore. Where the subterranean formation comprises acid-soluble components, such as those present in carbonate and sandstone formations, stimulation is often achieved by contacting the formation with a treatment fluid comprising an acid source. These acid stimulation treatments are often referred to as “acidizing” the formation. For example, where hydrochloric acid contacts and reacts with calcium carbonate in a formation, the calcium carbonate is consumed to produce water, carbon dioxide, and calcium chloride. After acidization is completed, the water and salts dissolved therein may be recovered by producing them to the surface, e.g., “flowing back” the well, leaving a desirable amount of channels (e.g., wormholes) within the formation, which enhance the formation's permeability and may increase the rate at which hydrocarbons may subsequently be produced from the formation. One method of acidizing, known as “fracture acidizing,” comprises injecting an acidizing treatment fluid into the formation at a pressure sufficient to create or enhance one or more fractures within the subterranean formation. Another method of acidizing, known as “matrix acidizing,” comprises injecting the acidizing treatment fluid into the formation at a pressure below that which would create or enhance a fracture within the subterranean formation.

In order to enhance acidizing treatments, various additives may be added to the acidizing treatment fluid. One such additive is a gelling agent typically comprised of a natural gum or a synthetic polymer. Among other things, gelling agents are added to increase viscosity of the acidizing treatment fluid for improved diversion and particulate suspension, increase penetration into the reservoir by decreasing the reactivity of such fluid, and/or reduce pumping requirements by reducing friction in the well bore. Moreover, to further enhance acid stimulation treatments, self-diverting acid treatments that use a gelling agent may be used. Among other things, a self-diverting acid treatment acts to effectively place the acid in a desired region within the subterranean formation, thereby creating a more optimal interaction of the acid with the acid-soluble components of the formation to create a desired network of channels that may penetrate deeper into the formation than a conventional acid stimulation treatment. One such self-diverting acidizing treatment fluid includes a crosslinkable gelling agent, a crosslinking agent, and a buffer to provide a crosslink within a certain pH range. A crosslinkable gelling agent comprising crosslinkable polyacrylamide-based polymers has been found to be useful in calcium carbonate formations.

Despite the advantages of using gelling agents in acid treatments, such treatments may be problematic. For example, conventional gelling agents may not be compatible with sulfide scavengers. Sulfide scavengers may be added to the acidizing treatment fluid in wells that contain sulfides (such as sulfide ions, hydrogen sulfide, and/or other sulfide containing compounds), inter alia, to combat problems associated with iron precipitation, acid corrosion, and/or sulfide cracking. When conventional crosslinkable gelling agents are placed in contact with sulfide scavengers, such gelling agents may form crosslinks with the sulfide scavengers, which may result in an undesirable increase in the viscosity of the acidizing treatment fluid. This increase in viscosity prior to its injection into the subterranean formation is problematic for a number of reasons. For example, if the crosslink occurs prior to the acidizing treatment fluids injection into the well, the pumping requirements required may significantly increase. Other problems may include, inter alia, higher friction pressures in the tubulars, higher injection pressures into the formation, and skin damage caused by the crosslinked gelling agent plugging the formation's face. As a result of this incompatibility, the use of conventional self-diverting acid treatments in wells that contain sulfides is undesirable.

Another problem experienced with the use of acidizing treatment fluids comprising conventional crosslinkable gelling agents is that the hydration times of such gelling agents may require the mixing of the acidizing treatment fluids in holding tanks for a considerable length of time. Among other things, this may be problematic during fracture acidizing where “on the fly mixing” may be desired. For example, because of the time required for hydration of conventional crosslinkable gelling agents, changes in acidizing treatment fluids cannot be made in real time (e.g., “on the fly”) in response to continuously monitored downhole parameters.

### SUMMARY OF THE INVENTION

The present invention relates to subterranean treatment operations, and more specifically, to improved acidizing treatment fluids that are compatible with sulfide scavengers and methods of using such acidizing treatment fluids in subterranean formations.

An exemplary method of the present invention of acidizing a subterranean formation comprises contacting the subterranean formation with an acidizing treatment fluid that comprises a base fluid that comprises an acid, a crosslinkable gelling agent that comprises a copolymer of an alkenoic acid and an acrylamide derivative, and a crosslinking agent.

An exemplary method of the present invention of diverting an acidizing treatment fluid in a subterranean formation comprises contacting the subterranean formation with an acidizing treatment fluid that comprises a base fluid that comprises an acid, a crosslinkable gelling agent that comprises a copolymer of an alkenoic acid and an acrylamide derivative, and a crosslinking agent; allowing the acidizing treatment fluid to react with the subterranean formation; and allowing the crosslinkable gelling agent to crosslink, thereby diverting the acidizing treatment fluid to a different location in the subterranean formation.

An exemplary embodiment of the acidizing treatment fluids of the present invention comprises a base fluid that comprises an acid, a crosslinkable gelling agent that comprises a copolymer of an alkenoic acid and an acrylamide derivative, and a crosslinking agent.

The features and advantages of the present invention will be readily apparent to those skilled in the art upon a reading of the description of the exemplary embodiments, which follows.

### DESCRIPTION OF EXEMPLARY EMBODIMENTS

The present invention relates to subterranean treatment operations, and more specifically, to improved acidizing treatment fluids that are compatible with sulfide scavengers and methods of using such acidizing treatment fluids in subterranean formations. While the compositions and methods of the present invention are useful in a variety of applications such as well bore cleanup, matrix acidizing, and fracture acidizing, they may be particularly useful in the stimulation (e.g., matrix acidizing and fracture acidizing) of a sour well.

The acidizing treatment fluids of the present invention comprise a base fluid that comprises an acid, a crosslinkable gelling agent that is compatible with a sulfide scavenger, and a crosslinking agent. Optionally, the acidizing treatment fluids may further comprise a sulfide scavenger. Other additives suitable for use in conjunction with the acidizing treatment fluids of the present invention may be added if desired.

The base fluid used in the acidizing treatment fluids of the present invention generally comprises an aqueous component and an acid. The aqueous component present in the base fluid may include fresh water, salt water (e.g., water containing one or more salts dissolved therein), brine (e.g., saturated salt water), or seawater. Generally, the aqueous component may be from any source provided that it does not adversely affect other components in the base fluid or the acidizing treatment fluids formed therewith.

The acid included in the base fluid may be any of a variety of acids commonly used in acidizing a subterranean formation. Examples of suitable acids include, but are not limited to, hydrochloric acid, hydrofluoric acid, formic acid, phosphoric acid, acetic acid, and various mixtures thereof. The concentration of the acid(s) employed may vary depending on the type of acid(s) used, the particular application (including formation characteristics and conditions), and other factors known to those skilled in the art. In an exemplary embodiment, where the base fluid contains hydrochloric acid, the hydrochloric acid may be present in the base fluid in an amount in the range of from about 5% to about 30% of the hydrochloric acid by weight of the base fluid. In choosing the appropriate base fluid, one should be mindful that the crosslinkable gelling agents of the present invention may not hydrate in the presence of base fluids at or below 1% hydrochloric acid by weight. One of ordinary skill in the art with the benefit of this disclosure will be able to determine the appropriate acid(s) and concentration of such acid(s) to use in the base fluid.

The crosslinkable gelling agents used in the acidizing treatment fluids of the present invention should be any crosslinkable gelling agent that is compatible with sulfide scavengers. As referred to herein, compatibility with a sulfide scavenger refers to a crosslinkable gelling agent that should not readily form crosslinks with a sulfide scavenger. The crosslinkable gelling agent preferably comprises a copolymer of an alkenoic acid and an acrylamide derivative. A variety of alkenoic acids may be suitable, including, but not limited to, 2-propenoic acid, 2-methyl-2-propenoic acid, 2-ethyl-2-propenoic acid, 2-propyl-2-propenoic acid, 3-methyl-2-propenoic acid, 3-ethyl-2-propenoic acid, 3-propyl-2-propenoic acid, 3-methyl-2-methyl-2-propenoic acid, and 3-ethyl-3-methyl-2-propenoic acid. In an exemplary embodiment, the acrylamide derivative comprises an alkyl acrylamide quaternary amine. In some embodiments, the quaternary amine comprises a trimethyl quaternary amine. An example of a suitable crosslinkable gelling agent that comprises a copolymer of an alkenoic acid and an acrylamide derivative is commercially available as “SDA-IV” from Halliburton Energy Services, Duncan, Okla. The crosslinkable gelling agent may be used in subterranean temperatures ranging up to about 240° F. In an exemplary embodiment, the crosslinkable gelling agent may be used in subterranean temperatures ranging up to about 225° F.

The crosslinkable gelling agent may be present in the acidizing treatment fluids of the present invention in an amount sufficient, inter alia, to provide the desired degree of diversion of the acidizing treatment fluid within the subterranean formation. In certain exemplary embodiments, the crosslinkable gelling agent may be present in the acidizing treatment fluids of the present invention in an amount in the range of from about 0.1% to about 5% by weight of the acidizing treatment fluid. In other exemplary embodiments, the crosslinkable gelling agent may be present in the acidizing treatment fluids of the present invention in an amount in the range of from about 0.3% to about 1.2% by weight of the acidizing treatment fluid.

According to the methods of the present invention, the crosslinkable gelling agents of the present invention, among other things, may increase diversion of the acidizing treatment fluids within the subterranean formation, and thus, create an optimal network of channels within the formation. Accordingly, the crosslinkable gelling agent may crosslink in the presence of crosslinking agents at an appropriate pH, e.g., in the range of from about 2.5 to about 3.0. Furthermore, the crosslinkable gelling agent should substantially hydrate in the presence of the base fluid. Moreover, in certain preferred embodiments, the crosslinkable gelling agents of the present invention should have a relatively short hydration time when compared to other gelling agents. For example, the crosslinkable gelling agents may fully hydrate within 20 minutes when combined with a base fluid having a concentration of 5% hydrochloric acid by weight. As a result, the crosslinkable gelling agents of the present invention are suitable for uses where a relatively short hydration time is preferred (e.g., on the fly mixing). Furthermore, due to its short hydration times, the crosslinkable gelling agent may act, inter alia, to reduce pumping requirements by reducing friction. For example, it is believed that the crosslinkable gelling agent of the present invention may reduce friction by organizing fluid flow to allow for a longer period of laminar flow for the acidizing treatment fluids of the present invention.

The acidizing treatment fluids of the present invention further comprise a crosslinking agent for crosslinking the crosslinkable gelling agent. A variety of crosslinking agents are suitable for use in the acidizing treatment fluids of the present invention. Examples of suitable crosslinking agents include, but are not limited to, compounds that may supply zirconium ions such as, for example, zirconium lactate, zirconium lactate triethanolamine, zirconium carbonate, zirconium acetylacetonate and zirconium diisopropylamine lactate; compounds that may supply iron ions, such as ferric chloride; compounds that may supply titanium ions such as, for example, titanium ammonium lactate, titanium triethanolamine, titanium acetylacetonate; aluminum compounds such as aluminum lactate or aluminum citrate; or compounds that may supply antimony ions. Further, the crosslinking agent should be present in the acidizing treatment fluids of the present invention in an amount sufficient, inter alia, to provide the desired degree of crosslinking within the acidizing treatment fluid. In certain exemplary embodiments, the crosslinking agent of the present invention is present in the acidizing treatment fluids of the present invention in an amount in the range of from about 50 parts per million (“ppm”) to about 5,000 ppm active crosslinker. The exact type and amount of crosslinking agent or agents used depends upon the specific crosslinkable gelling agent to be crosslinked, formation temperature conditions, and other factors known to those individuals skilled in the art.

The acidizing treatment fluids of the present invention may further comprise a sulfide scavenger. Among other things, sulfide scavengers are used in such fluids to inhibit the precipitation of iron, which may reduce the permeability of the formation by covering or otherwise inhibiting the flow of desirable fluids from the pore throats of the formation. Generally, the sulfide scavengers may be any compound that inhibits such precipitation without any adverse effects on the other components of the acidizing treatment fluid. In an exemplary embodiment, the sulfide scavengers may comprise any compound capable of forming aldehydes in solution such as aldehydes, acetals, hemicetals, or the like. Examples of suitable aldehydes include, but are not limited to, aldol, butyraldehyde, heptaldehyde, propionaldehyde, formaldehyde, acetaldehyde, benzaldehyde, difunctional aldehydes (e.g., glutaraldehyde), and derivatives of such aldehydes. In an exemplary embodiment, the sulfide scavengers of the present invention have a relatively low molecular weight in comparison to other suitable sulfide scavengers. However, aldehydes with relatively low molecular weights tend to have a higher vapor pressure, which may make them difficult to handle. In an exemplary embodiment, the sulfide scavenger of the present invention comprises aldol (beta-hydroxybutyraldehyde) due to its low molecular weight and low vapor pressure. Furthermore, the nature of the reaction product between aldehydes and sulfides varies depending upon the particular aldehyde chosen. For example, formaldehyde combines with sulfide to yield trithiane (C₃H₃S₃), which is stable in acid solutions.

The amount of the sulfide scavenger that may be used varies depending upon many factors such as the amount of sulfides present and the type of acid used. Generally, the sulfide scavenger may be present in the acidizing treatment fluids of the present invention in an amount sufficient to prevent precipitation during treatment and until such acidizing treatment fluid can be recovered from the well. In certain exemplary embodiments, the sulfide scavenger is present in the acidizing treatment fluids of the present invention in an amount in the range of from about 0.25% to about 5% by weight of the acidizing treatment fluid. In another exemplary embodiment, the sulfide scavenger is present in the acidizing treatment fluids of the present invention in an amount in the range of from about 1% to about 4% by weight of the acidizing treatment fluid.

Another optional additive that may be included in the acidizing treatment fluids of the present invention includes an iron sequestering agent. Any iron sequestering agent capable of reacting with iron present in the solution and decreasing the amount of iron capable of reacting with sulfides present in the solution may be used. Examples of suitable iron sequestering agents include, but are not limited to, aminopolycarboxylic acids, citric acids, hydroxycarboxylic acids, cyclic polyethers, and derivatives of such acids and ethers. In an exemplary embodiment, the iron sequestering agent is present in the acidizing treatment fluids of the present invention in an amount in the range of from about 0.25% to about 5% by weight of the acidizing treatment fluid.

Optionally, additional additives may be added to the acidizing treatment fluids of the present invention as deemed appropriate by one skilled in the art with the benefit of this disclosure. Examples of such additives include, but are not limited to, corrosion inhibitors, fluid loss additives, demulsifiers, reducing agents, paraffin inhibitors, asphaltene inhibitors, scale control additives, and/or surfactants.

In one embodiment of the methods of the present invention, the acidizing treatment fluids of the present invention may be placed in a subterranean formation, and permitted to react therein for a desired amount of time, after which the well may be placed on production in order to flow back the dissolved salts (e.g., calcium formate) and the like. One of ordinary skill in the art, with the benefit of this disclosure, may determine the appropriate amount of residence time within the subterranean formation by a variety of methods. For example, one of ordinary skill in the art may contact a sample of the acidizing treatment fluid with powdered calcium carbonate, and follow the kinetics of the reaction at the temperature of interest, and incorporate the information learned thereby into the determination of the appropriate residence time.

The acidizing treatment fluids of the present invention may be prepared by any suitable method. In an exemplary embodiment of the methods of the present invention, the acidizing treatment fluids of the present invention may be prepared on the job site in a very rapid manner. Because of the short hydration time of the crosslinkable gelling agent used in the acidizing treatment fluids of the present invention, it does not need to be mixed with the acidizing treatment fluid for a considerable length of time. For example, the preparation of the acidizing treatment fluids of the present invention may involve metering and/or adding the individual components of such fluid into a blender wherein they are mixed. After allowing for a short hydration time of the crosslinkable gelling agent, the acidizing treatment fluid may then be substantially pumped out of the blender and into the subterranean formation by way of a well bore. In such a method, the time lapse from when the metering, mixing and pumping process starts to when the acidizing treatment fluid reaches the subterranean formation may be only a few minutes. This allows changes in the properties of the acidizing treatment fluid to be made on the surface as required during the time the acidizing treatment fluid is being pumped. For example, in a fracture acidizing procedure carried out in a subterranean formation, changes can be made to the acidizing treatment fluid in response to continuously monitored downhole parameters to achieve desired fracturing results.

Preferably, the acidizing treatment fluid should be recovered from the subterranean formation after it has become substantially spent or after the well has been sufficiently treated. Generally, the acidizing treatment fluid may be recovered by producing the formation, by driving the acidizing treatment fluid to a recovery well, or by driving the acidizing treatment fluid over such a wide area within the formation that any precipitate that forms may not have a detrimental effect.

An exemplary method of the present invention of acidizing a subterranean formation comprises contacting the subterranean formation with an acidizing treatment fluid that comprises a base fluid that comprises an acid, a crosslinkable gelling agent that comprises a copolymer of an alkenoic acid and an acrylamide derivative, and a crosslinking agent.

An exemplary method of the present invention of diverting an acidizing treatment fluid in a subterranean formation comprises contacting the subterranean formation with an acidizing treatment fluid that comprises a base fluid that comprises an acid, a crosslinkable gelling agent that comprises a copolymer of an alkenoic acid and an acrylamide derivative, and a crosslinking agent; allowing the acidizing treatment fluid to react with the subterranean formation; and allowing the crosslinkable gelling agent to crosslink, thereby diverting the acidizing treatment fluid to a different location in the subterranean formation.

An exemplary embodiment of the acidizing treatment fluids of the present invention comprises a base fluid that comprises an acid, a crosslinkable gelling agent that comprises a copolymer of an alkenoic acid and an acrylamide derivative, and a crosslinking agent.

To facilitate a better understanding of the present invention, the following examples of preferred embodiments are given. In no way should the following examples be read to limit, or to define, the scope of the invention.

### EXAMPLES

### Example 1

A benchtop demonstration was performed using three fluid samples. Fluid samples were prepared by adding 3 milliliters (“ml”) of a crosslinkable gelling agent to 196 ml of a 15% hydrochloric acid solution in a Waring blender while stirring. Next, the gelling agent was allowed to hydrate for a period of one hour. After this hydration period, 0.4 ml of hydroxyacetic acid, 8 ml of aldol, 2 ml of ferric chloride, and 0.1 grams of an iron reducing agent were added to the samples. To check for any signs of crosslinking, visual observations of the fluid samples were conducted over a period of about one week. A summary of the time required for crosslinking demonstrated by each fluid sample is depicted in Table 1, below.

TABLE 1

| | TIME PERIOD FOR |
|---|---|
| FLUID | CROSSLINKING |
| Fluid Sample No. 1 | within 1 hour |
| (comparative) | |
| Fluid Sample No. 2 | within 1 hour |
| (comparative) | |
| Fluid Sample No. 3 | None |

Fluid Sample No. 1 (comparative) consisted of 3 ml of a first conventional polyacrylamide-based copolymer crosslinkable gelling agent, 196 ml of a 15% hydrochloric acid solution, 0.4 milliliters of hydroxyacetic acid, 8 ml of aldol, 2 ml of ferric chloride, and 0.1 grams of an iron reducing agent. Crosslinking of the first conventional crosslinkable gelling agent with aldol was observed within 1 hour. Further, after one day, Fluid Sample No. 1 had formed a lipping gel.

Fluid Sample No. 2 (comparative) consisted of 3 ml of a second conventional polyacrylamide-based copolymer crosslinkable gelling agent, 196 ml of a 15% hydrochloric acid solution, 0.4 milliliters of hydroxyacetic acid, 8 ml of aldol, 2 ml of ferric chloride, and 0.1 grams of an iron reducing agent. Crosslinking of the second conventional crosslinkable gelling agent with aldol was observed within 1 hour. After one day, Fluid Sample No. 2 had formed a lipping gel.

Fluid Sample No. 3 consisted of 3 ml of SDA-IV, 196 ml of a 15% hydrochloric acid solution, 0.4 milliliters of hydroxyacetic acid, 8 ml of aldol, 2 ml of ferric chloride, and 0.1 grams of an iron reducing agent. SDA-IV comprises a crosslinkable gelling agent of the present invention. After one week, no crosslinking between the crosslinkable gelling agent of the present invention and aldol were observed.

Thus, Example 1 demonstrates, inter alia, that Fluid Sample No. 3, an acidizing treatment fluid of the present invention comprising a crosslinkable gelling agent, may be compatible with a sulfide scavenger.

### Example 2

An additional test was performed using a crosslinkable gelling agent of the present invention. To Fluid Sample No. 3, calcium carbonate powder was slowly added until most of the acid was spent and crosslinking occurred. During the addition of the calcium carbonate powder, the sample was observed to determine the degree of crosslinking. Visual observations demonstrated that a strong crosslink was formed at a desired pH, in the range of from about 2.5 to about 3. Subsequently, additional calcium carbonate power was added until the acid was fully neutralized.

Thus, Example 2 demonstrates, inter alia, that Fluid Sample No. 3, an acidizing treatment fluid of the present invention comprising a crosslinkable gelling agent, provides a crosslink at an appropriate pH.

Therefore, the present invention is well adapted to carry out the objects and attain the ends and advantages mentioned as well as those which are inherent therein. While numerous changes may be made by those skilled in the art, such changes are encompassed within the spirit of this invention as defined by the appended claims.

1. A method of acidizing a subterranean formation comprising the steps of:
contacting the subterranean formation with an acidizing treatment fluid that comprises:
a base fluid that comprises an acid,
a crosslinkable gelling agent that comprises a copolymer of an alkenoic acid and an acrylamide derivative, and
a crosslinking agent.

2. The method of claim 1 wherein the acid comprises hydrochloric acid, hydrofluoric acid, formic acid, phosphoric acid, acetic acid, or a mixture thereof.

3. The method of claim 1 wherein the alkenoic acid comprises 2-propenoic acid, 2-methyl-2-propenoic acid, 2-ethyl-2-propenoic acid, 2-propyl-2-propenoic acid, 3-methyl-2-propenoic acid, 3-ethyl-2-propenoic acid, 3-propyl-2-propenoic acid, 3-methyl-2-methyl-2-propenoic acid, or 3-ethyl-3-methyl-2-propenoic acid.

4. The method of claim 1 wherein the acryalmide derivative comprises an alkyl acrylamide quaternary amine.

5. The method of claim 1 wherein the acryalmide derivative comprises an alkyl acrylamide trimethyl quaternary amine.

6. The method of claim 1 wherein the crosslinkable gelling agent is present in the acidizing treatment fluid in the range of from about 0.1% to about 5 % by weight of the acidizing treatment fluid.

7. The method of claim 1 wherein the crosslinking agent comprises a compound that supplies zirconium ions, a compound that supplies iron ions, a compound that supplies titanium ions, an aluminum compound, or a compound that supplies antimony ions.

8. The method of claim 1 wherein the crosslinking agent is present in the acidizing treatment fluid in an amount in the range of from about 50 parts per million to about 5,000 parts per million.

9. The method of claim 1 wherein the acidizing treatment fluid further comprises a sulfide scavenger.

10. The method of claim 9 wherein the sulfide scavenger comprises an aldehyde, an acetal, or a hemicetal.

11. The method of claim 9 wherein the sulfide scavenger comprises aldol.

12. The method of claim 9 wherein the sulfide scavenger is present in the acidizing treatment fluid in the range of from about 0.25% to about 5% by weight of the acidizing treatment fluid.

13. The method of claim 1 wherein the acidizing treatment fluid further comprises an iron sequestering agent.

14. The method of claim 13 wherein the iron sequestering agent comprises an aminopolycarboxylic acid, a hydroxycarboxylic acid, or a cyclic polyether.

15. The method of claim 13 wherein the iron sequestering agent is present in the acidizing treatment fluid in the range of from about 0.25% to about 5% by weight of the acidizing treatment fluid.

16. The method of claim 1 wherein the acidizing treatment fluid further comprises a corrosion inhibitor, a fluid loss control additive, a demulsifier, a reducing agent, a paraffin inhibitor, an asphaltene inhibitor, a scale control additive, or a surfactant.

17. The method of claim 1 wherein the acidizing treatment fluid is prepared on the fly in response to continuously monitored downhole parameters.

18. The method of claim 1 further comprising the step of recovering the acidizing treatment fluid from the subterranean formation.

19. A method of diverting an acidizing treatment fluid in a subterranean formation comprising the steps of:
contacting the subterranean formation with an acidizing treatment fluid that comprises:
a base fluid that comprises an acid,
a crosslinkable gelling agent that comprises a copolymer of an alkenoic acid and an acrylamide derivative, and
a crosslinking agent;
allowing the acidizing treatment fluid to react with the subterranean formation; and
allowing the crosslinkable gelling agent to crosslink, thereby diverting the acidizing treatment fluid to a different location in the subterranean formation.

20. The method of claim 19 wherein the acid comprises hydrochloric acid, hydrofluoric acid, formic acid, phosphoric acid, acetic acid, or a mixture thereof.

21. The method of claim 19 wherein the alkenoic acid comprises 2-propenoic acid, 2-methyl-2-propenoic acid, 2-ethyl-2-propenoic acid, 2-propyl-2-propenoic acid, 3-methyl-2-propenoic acid, 3-ethyl-2-propenoic acid, 3-propyl-2-propenoic acid, 3-methyl-2-methyl-2-propenoic acid, or 3-ethyl-3-methyl-2-propenoic acid.

22. The method of claim 19 wherein the acrylamide derivative comprises an alkyl acrylamide quaternary amine.

23. The method of claim 19 wherein the acrylamide derivative comprises an alkyl acrylamide trimethyl quaternary amine.

24. The method of claim 19 wherein the crosslinkable gelling agent is present in the acidizing treatment fluid in the range of from about 0.1% to about 5% by weight of the acidizing treatment fluid.

25. The method of claim 19 wherein the crosslinking agent comprises a compound that supplies zirconium ions, a compound that supplies iron ions, a compound that supplies titanium ions, an aluminum compound, or a compound that supplies antimony ions.

26. The method of claim 19 wherein the crosslinking agent is present in the acidizing treatment fluid in an amount in the range of from about 50 parts per million to about 5,000 parts per million.

27. The method of claim 19 wherein the acidizing treatment fluid further comprises a sulfide scavenger.

28. The method of claim 27 wherein the sulfide scavenger comprises an aldehyde, an acetal, or a hemicetal.

29. The method of claim 27 wherein the sulfide scavenger comprises aldol.

30. The method of claim 27 wherein the sulfide scavenger is present in the acidizing treatment fluid in the range of from about 0.25% to about 5% by weight of the acidizing treatment fluid.

31. The method of claim 19 wherein the acidizing treatment fluid further comprises an iron sequestering agent.

32. An acidizing treatment fluid comprising:
a base fluid that comprises an acid,
a crosslinkable gelling agent that comprises a copolymer of an alkenoic acid and an acrylamide derivative, and
a crosslinking agent.

33. The acidizing treatment fluid of claim 32 wherein the acid comprises hydrochloric acid, hydrofluoric acid, formic acid, phosphoric acid, acetic acid, or a mixture thereof.

34. The acidizing treatment fluid of claim 32 wherein the acid is hydrochloric acid and the base fluid has an acid concentration in the range of from about 5% to about 30% acid by weight of the base fluid.

35. The acidizing treatment fluid of claim 32 wherein the alkenoic acid comprises 2-propenoic acid, 2-methyl-2-propenoic acid, 2-ethyl-2-propenoic acid, 2-propyl-2-propenoic acid, 3-methyl-2-propenoic acid, 3-ethyl-2-propenoic acid, 3-propyl-2-propenoic acid, 3-methyl-2-methyl-2-propenoic acid, or 3-ethyl-3-methyl-2-propenoic acid.

36. The acidizing treatment fluid of claim 32 wherein the acrylamide derivative comprises an alkyl acrylamide quaternary amine.

37. The acidizing treatment fluid of claim 32 wherein the acrylamide derivative comprises an alkyl acrylamide trimethyl quaternary amine.

38. The acidizing treatment fluid of claim 32 wherein the crosslinkable gelling agent is present in the acidizing treatment fluid in the range of from about 0.1% to about 5% by weight of the acidizing treatment fluid.

39. The acidizing treatment fluid of claim 32 wherein the crosslinking agent comprises a compound that supplies zirconium ions, a compound that supplies iron ions, a compound that supplies titanium ions, an aluminum compound, or a compound that supplies antimony ions.

40. The acidizing treatment fluid of claim 32 wherein the crosslinking agent is present in the acidizing treatment fluid in an amount in the range of from about 50 parts per million to about 5,000 parts per million.

41. The acidizing treatment fluid of claim 32 wherein the acidizing treatment fluid further comprises a sulfide scavenger.

42. The acidizing treatment fluid of claim 41 wherein the sulfide scavenger comprises an aldehyde, an acetal, or a hemicetal.

43. The acidizing treatment fluid of claim 41 wherein the sulfide scavenger comprises aldol.

44. The acidizing treatment fluid of claim 41 wherein the sulfide scavenger is present in the acidizing treatment fluid in the range of from about 0.25% to about 5% by weight of the acidizing treatment fluid.

45. The acidizing treatment fluid of claim 32 wherein the acidizing treatment fluid further comprises an iron sequestering agent.

46. The acidizing treatment fluid of claim 45 wherein the iron sequestering agent comprises an aminopolycarboxylic acid, a hydroxycarboxylic acid, or a cyclic polyether.

47. The acidizing treatment fluid of claim 45 wherein the iron sequestering agent is present in the acidizing treatment fluid in the range of from about 0.25% to about 5% by weight of the acidizing treatment fluid.

48. The acidizing treatment fluid of claim 32 wherein the acidizing treatment fluid further comprises a corrosion inhibitor, a fluid loss control additive, a demulsifier, a reducing agent, a paraffin inhibitor, an asphaltene inhibitor, a scale control additive, or a surfactant.
